(19) United States
(12) Patent Application Publication
(10) Pub. No.: US 2021/0404803 A1
(43) Pub. Date: Dec. 30, 2021

(54) ROAD SURFACE INCLINATION ANGLE CALCULATION DEVICE

(71) Applicant: TOYOTA JIDOSHA KABUSHIKI KAISHA, Toyota-shi (JP)

(72) Inventor: Hideaki BUNAZAWA, Nagoya-shi (JP)

(73) Assignee: TOYOTA JIDOSHA KABUSHIKI KAISHA, Toyota-shi (JP)

(21) Appl. No.: 17/350,324

(22) Filed: Jun. 17, 2021

(30) Foreign Application Priority Data
Jun. 25, 2020 (JP) 2020-109676

(51) Int. Cl. G01C 1/00; B60W 40/076

(52) U.S. Cl. CPC G01C 1/00; B60W 2520/105; B60W 2520/30; B60W 40/076

(57) ABSTRACT

A road surface inclination angle calculation device includes a storage device configured to store mapping data that prescribes mapping, and an execution device. The mapping includes a front-rear acceleration variable and a drive wheel torque variable as input variables, and includes, as an output variable, an inclination angle variable that is a variable indicating the inclination angle of a road surface, on which a vehicle is traveling, for the travel direction of the vehicle. The execution device is configured to acquire the values of the input variables, and configured to calculate the value of the output variable by inputting the acquired values of the input variables to the mapping.

### CROSS-REFERENCE TO RELATED APPLICATION

This application claims priority to Japanese Patent Application No. 2020-109676 filed on Jun. 25, 2020, incorporated herein by reference in its entirety.

### BACKGROUND

### 1. Technical Field

The present disclosure relates to a road surface inclination angle calculation device.

### 2. Description of Related Art

Japanese Unexamined Patent Application Publication No. 2012-021786 (JP 2012-021786 A) discloses a road surface inclination angle calculation device that calculates an integrated value of each of parameters including a vehicle speed, a brake hydraulic pressure, and travel load torque during a period since the vehicle speed becomes equal to or less than a predetermined vehicle speed until the vehicle becomes stationary. When the vehicle becomes stationary, the road surface inclination angle calculation device calculates a travel resistance, a braking force, and travel load torque that act on the vehicle during the above period based on the integrated parameters. The road surface inclination angle calculation device calculates the inclination angle of the road surface based on the calculated parameters.

### SUMMARY

The road surface inclination angle calculation device described in JP 2012-021786 A requires that the vehicle needs to be decelerated and become stationary, in order to calculate the inclination angle of the road surface. Therefore, the road surface inclination angle calculation device described in JP 2012-021786 A cannot calculate the inclination angle of the road surface during travel of the vehicle.

A first aspect of the present disclosure provides a road surface inclination angle calculation device including a storage device configured to store mapping data that prescribes mapping, and an execution device. The mapping includes, as input variables, a front-rear acceleration variable that is a variable indicating an acceleration of a vehicle in a front-rear direction, and a drive wheel torque variable that is a variable indicating torque of a drive wheel of the vehicle. The mapping includes, as an output variable, an inclination angle variable that is a variable indicating an inclination angle of a road surface on which the vehicle is traveling for a travel direction of the vehicle. The execution device is configured to acquire values of the input variables and configured to calculate a value of the output variable by inputting the acquired values of the input variables to the mapping.

When the acceleration of the vehicle in the front-rear direction is constant, the inclination angle of the road surface becomes larger as torque of the drive wheel is increased. That is, the inclination angle of the road surface depends on the front-rear acceleration variable and the drive wheel torque variable. Therefore, with the road surface inclination angle calculation device according to the first aspect of the present disclosure, the inclination angle of the road surface can be calculated by performing a calculation process using the input variables as inputs. The inclination angle of the road surface can be calculated at all times during travel of the vehicle, by performing a calculation process using the input variables as inputs during travel of the vehicle.

In the road surface inclination angle calculation device according to the first aspect of the present disclosure, the input variables may include a vehicle speed variable that is a variable corresponding to a travel speed of the vehicle. An air resistance acts on the vehicle during travel of the vehicle. The air resistance is increased in accordance with the travel speed of the vehicle. Thus, with the road surface inclination angle calculation device according to the first aspect of the present disclosure, the inclination angle of the road surface can be calculated based on the travel state of the vehicle that is determined in consideration of the air resistance, by including the vehicle speed variable in the input variables. Thus, the precision in calculating the inclination angle of the road surface is improved.

In the road surface inclination angle calculation device according to the first aspect of the present disclosure, the input variables may include a weight variable that is a variable corresponding to a weight of the vehicle. A rolling resistance due to friction between the road surface and the wheel acts on the vehicle during travel of the vehicle. The rolling resistance is increased in accordance with the weight of the vehicle. Thus, with the road surface inclination angle calculation device according to the first aspect of the present disclosure, the inclination angle of the road surface can be calculated based on the travel state of the vehicle that is determined in consideration of the rolling resistance, by including the weight variable in the input variables. Thus, the precision in calculating the inclination angle of the road surface is improved.

In the road surface inclination angle calculation device according to the first aspect of the present disclosure, the input variables may include an extension inclination angle variable that is a variable indicating the inclination angle of the road surface for an extension direction of a road at a present position of the vehicle, and the extension inclination angle variable may be determined in advance as map information stored in the storage device.

With the road surface inclination angle calculation device according to the first aspect of the present disclosure, the precision in calculating the inclination angle of the road surface in the travel direction of the vehicle is improved by reflecting the inclination angle of the road surface for the extension direction of the road, or a rough inclination angle of the road surface, in the calculation of the inclination angle of the road surface.

A second aspect of the present disclosure provides a road surface inclination angle calculation device including a storage device configured to store mapping data that prescribes mapping, and an execution device. The mapping includes, as input variables, a front-rear acceleration variable that is a variable indicating an acceleration of a vehicle in a front-rear direction, a drive source torque variable that is a variable indicating output torque of a drive source of the vehicle, a gear ratio variable that is a variable indicating a gear ratio of a power transfer system that is provided on a power transfer pass between the drive source and a drive wheel in the vehicle, and a braking variable that is a variable indicating a braking force of a braking device of the vehicle. The mapping includes, as an output variable, an inclination angle variable that is a variable indicating an inclination angle of a road surface on which the vehicle is traveling for a travel direction of the vehicle. The execution device is configured to acquire values of the input variables and configured to calculate a value of the output variable by inputting the acquired values of the input variables to the mapping.

A value obtained by subtracting the braking variable from the product of the drive source torque variable and the gear ratio variable reflects torque of the drive wheel. When the acceleration of the vehicle in the front-rear direction is constant, the inclination angle of the road surface becomes larger as torque of the drive wheel is increased. That is, the inclination angle of the road surface depends on the front-rear acceleration variable, the drive source torque variable, the gear ratio variable, and the braking variable. Therefore, with the road surface inclination angle calculation device according to the second aspect of the present disclosure, the inclination angle of the road surface can be calculated by performing a calculation process using the input variables as inputs. The inclination angle of the road surface can be calculated at all times during travel of the vehicle, by performing a calculation process using the input variables as inputs during travel of the vehicle.

In the road surface inclination angle calculation device according to the second aspect of the present disclosure, the input variables may include a vehicle speed variable that is a variable corresponding to a travel speed of the vehicle. An air resistance acts on the vehicle during travel of the vehicle. The air resistance is increased in accordance with the travel speed of the vehicle. Thus, with the road surface inclination angle calculation device according to the second aspect of the present disclosure, the inclination angle of the road surface can be calculated based on the travel state of the vehicle that is determined in consideration of the air resistance, by including the vehicle speed variable in the input variables. Thus, the precision in calculating the inclination angle of the road surface is improved.

In the road surface inclination angle calculation device according to the second aspect of the present disclosure, the input variables may include a weight variable that is a variable corresponding to a weight of the vehicle. A rolling resistance due to friction between the road surface and the wheel acts on the vehicle during travel of the vehicle. The rolling resistance is increased in accordance with the weight of the vehicle. Thus, with the road surface inclination angle calculation device according to the second aspect of the present disclosure, the inclination angle of the road surface can be calculated based on the travel state of the vehicle that is determined in consideration of the rolling resistance, by including the weight variable in the input variables. Thus, the precision in calculating the inclination angle of the road surface is improved.

In the road surface inclination angle calculation device according to the second aspect of the present disclosure, the input variables may include an extension inclination angle variable that is a variable indicating the inclination angle of the road surface for an extension direction of a road at a present position of the vehicle, and the extension inclination angle variable may be determined in advance as map information stored in the storage device.

With the road surface inclination angle calculation device according to the second aspect of the present disclosure, the precision in calculating the inclination angle of the road surface in the travel direction of the vehicle is improved by reflecting the inclination angle of the road surface for the extension direction of the road, or a rough inclination angle of the road surface, in the calculation of the inclination angle of the road surface.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a vehicle;

FIG. 2 is a flowchart illustrating the process procedure of a road surface inclination angle calculation process; and

FIG. 3 is a schematic diagram of a road surface inclination angle calculation system.

### DETAILED DESCRIPTION OF EMBODIMENTS

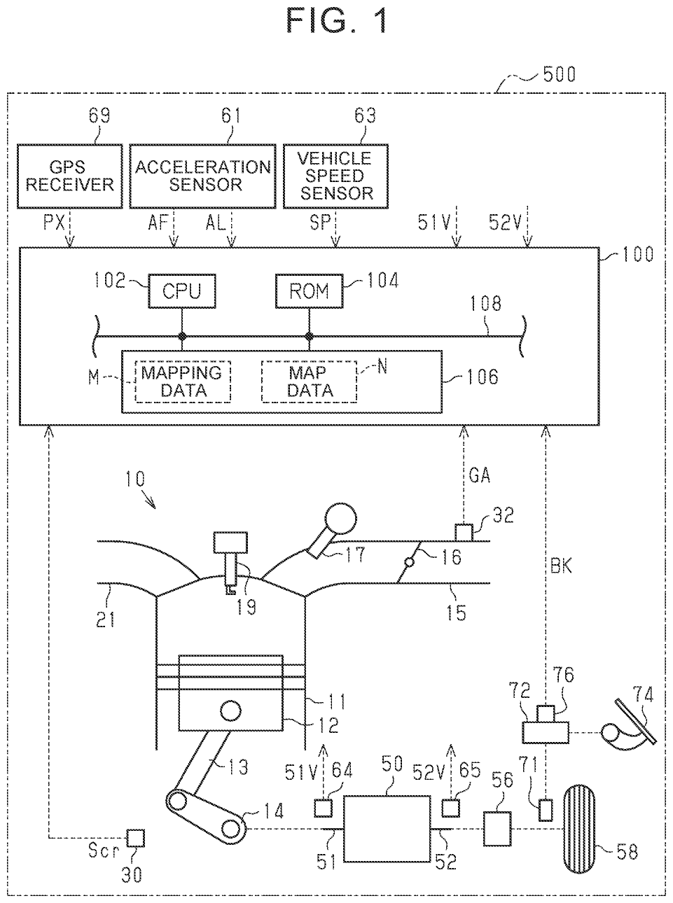

A road surface inclination angle calculation device according to an embodiment will be described below with reference to the drawings. First, a schematic configuration of a vehicle will be described. As illustrated in FIG. 1, an internal combustion engine 10 is mounted on a vehicle 500 to serve as a drive source of the vehicle 500. The internal combustion engine 10 has a cylinder 11 for combustion of a mixture of fuel and intake air. While a plurality of cylinders 11 is provided, only one of the cylinders 11 is illustrated in FIG. 1. A piston 12 is housed in the cylinder 11 so as to be reciprocally movable. The piston 12 is coupled to a crankshaft 14 via a connecting rod 13. The crankshaft 14 is rotated in accordance with reciprocal motion of the piston 12. A crank angle sensor 30 is disposed in the vicinity of the crankshaft 14 to detect a crank position Scr that is the rotational position of the crankshaft 14.

An intake passage 15 is connected to the cylinder 11 to introduce intake air from the outside into the cylinder 11. An air flow meter 32 is attached at the middle of the intake passage 15 to detect an intake air amount GA of intake air that flows through the intake passage 15. A throttle valve 16 is disposed in the intake passage 15 downstream of the air flow meter 32 to adjust the intake air amount GA of intake air to be introduced into the cylinder 11. A fuel injection valve 17 is attached in the intake passage 15 downstream of the throttle valve 16 to inject fuel. An exhaust passage 21 is connected to the cylinder 11 to discharge exhaust air in the cylinder 11 to the outside. The distal end of an ignition plug 19 is positioned in the cylinder 11 to ignite an air-fuel mixture in the cylinder 11.

An input shaft 51 of an automatic transmission 50 is coupled to the crankshaft 14 that is an output shaft of the internal combustion engine 10. Although not illustrated, a plurality of clutches and brakes as engagement elements and a plurality of planetary gear mechanisms is interposed between the input shaft 51 and an output shaft 52 of the automatic transmission 50. In the automatic transmission 50, the speed ratio is changed by switching the disengagement and engagement states of each of the engagement elements. An input shaft rotation sensor 64 is attached in the vicinity of the input shaft 51 of the automatic transmission 50 to detect a rotational position 51V of the input shaft 51. An output shaft rotation sensor 65 is attached in the vicinity of the output shaft 52 of the automatic transmission 50 to detect a rotational position 52V of the output shaft 52. The output shaft 52 of the automatic transmission 50 is coupled to a drive wheel 58 via a differential 56 etc.

A hydraulic brake 71 is attached to the drive wheel 58. A master cylinder 72 is connected to the brake 71 via a connection passage (not illustrated). The master cylinder 72 generates a hydraulic pressure that matches the amount of operation of a brake pedal 74. A braking force is applied to the drive wheel 58 when a hydraulic pressure generated in the master cylinder 72 is supplied to a hydraulic cylinder of the brake 71. A brake pressure sensor 76 is attached to the master cylinder 72 to detect a brake hydraulic pressure BK that is a pressure in the master cylinder 72. The brake 71, the master cylinder 72, the brake pedal 74, and the brake pressure sensor 76 constitute a braking device.

An acceleration sensor 61 is attached to the vehicle 500 to detect a front-rear acceleration AF that is the acceleration of the vehicle 500 in the front-rear direction. The acceleration sensor 61 also detects a right-left acceleration AL that is the acceleration of the vehicle 500 in the right-left direction. A vehicle speed sensor 63 is attached to the vehicle 500 to detect a vehicle speed SP that is the travel speed of the vehicle 500. A global positioning system (GPS) receiver 69 is attached to the vehicle 500 to detect a present position coordinate PX of the vehicle 500.

Next, the control configuration of the vehicle 500 will be described. Various types of control for the internal combustion engine 10, the automatic transmission 50, etc. are executed by a control device 100 mounted on the vehicle 500. The control device 100 may be constituted as one or more processors that execute various types of processes in accordance with a computer program (software). The control device 100 may be constituted as one or more dedicated hardware circuits such as application-specific integrated circuits (ASICs) that execute at least a part of the various types of processes, or circuitry that includes a combination of such circuits. The processor includes a central processing unit (CPU) 102 and a memory such as a random access memory (RAM) and a read only memory (ROM) 104. The memory stores program codes or instructions configured to cause the CPU 102 to execute the processes. The memory, which is a computer readable medium, includes any available medium that can be accessed by a general-purpose or dedicated computer. The control device 100 has a storage device 106. The storage device 106 is a non-volatile memory that is electrically rewritable. The CPU 102, the ROM 104, and the storage device 106 can communicate with each other through an internal bus 108. In the present embodiment, the CPU 102 and the ROM 104 constitute an execution device.

The storage device 106 stores mapping data M. The mapping data M are data that prescribes mapping to which various types of input variables (to be discussed later) are input and that outputs an output variable. The output variable is an inclination angle R of a road surface on which the vehicle 500 is traveling for the travel direction of the vehicle 500. Particularly, the inclination angle R is an acute angle formed between the travel direction of the vehicle 500 and the horizontal plane.

The storage device 106 stores map data N. The map data N includes road information. In the map data N, roads are indicated by a plurality of nodes and links that connect between adjacent nodes. The nodes are provided at intersections or at intervals of a predetermined distance, for example. In the map data N, the position coordinates of the nodes are set. The map data N include information on an inclination angle (hereinafter referred to as an “extension inclination angle”) Q of a road surface for the extension direction of the road. The extension inclination angle Q is the average inclination angle of a road surface for the extension direction of the road in the range from a specific node to an adjacent node on the map data N. That is, the extension inclination angle Q is the average inclination angle of a road surface seen at a scale of about 100 [m], for example. The extension inclination angle Q is set for each road on the map data N.

The storage device 106 stores a weight (hereinafter referred to as a “vehicle weight”) W of the vehicle 500. The storage device 106 stores various types of maps such as a map for calculating output torque of the internal combustion engine 10.

Detection signals from the various types of sensors attached to the vehicle 500 are input to the control device 100. Specifically, detection signals for the following parameters are input to the control device 100.

Crank position Scr detected by the crank angle sensor 30

Intake air amount GA detected by the air flow meter 32

Front-rear acceleration AF detected by the acceleration sensor 61

Right-left acceleration AL detected by the acceleration sensor 61

Vehicle speed SP detected by the vehicle speed sensor 63

Rotational position 51V of the input shaft 51 of the automatic transmission 50 detected by the input shaft rotation sensor 64

Rotational position 52V of the output shaft 52 of the automatic transmission 50 detected by the output shaft rotation sensor 65

Present position coordinate PX of the vehicle 500 detected by the GPS receiver 69

Brake hydraulic pressure BK detected by the brake pressure sensor 76

The CPU 102 of the control device 100 can execute a road surface inclination angle calculation process to calculate the inclination angle R of the road surface on which the vehicle 500 is traveling. As described above, the inclination angle R of the road surface is the inclination angle of the road surface for the travel direction of the vehicle 500. The CPU 102 implements various processes of the road surface inclination angle calculation process by executing a program stored in the ROM 104. The CPU 102 executes the road surface inclination angle calculation process repeatedly in predetermined control cycles since an ignition switch of the vehicle 500 is turned on until the ignition switch is turned off.

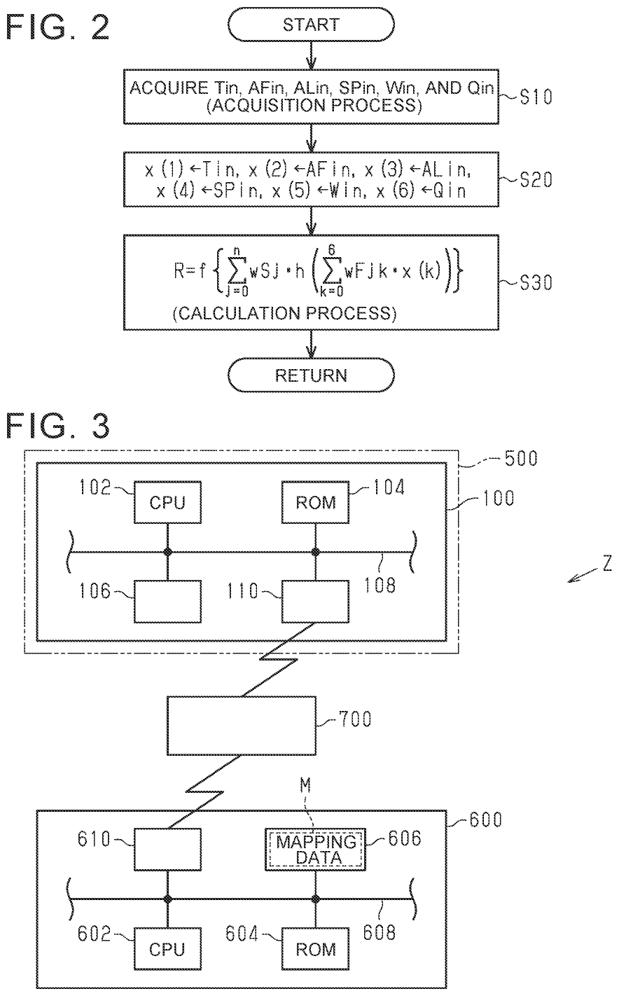

When the road surface inclination angle calculation process is started, as indicated in FIG. 2, the CPU 102 executes the process in step S10. In step S10, the CPU 102 acquires various types of variables for calculation that are necessary to calculate the inclination angle R of the road surface. Specific examples of the variables for calculation include torque (hereinafter referred to as “drive wheel torque”) Tin of the drive wheel 58, front-rear acceleration AFin, right-left acceleration ALin, a vehicle speed SPin, a vehicle weight Win, and an extension inclination angle Qin. Herein, the above variables are given “in” at the end of the sign to indicate that the variable is used for calculation, and are not given “in” otherwise.

When the vehicle 500 travels on a climbing road while maintaining a constant front-rear acceleration AF, higher drive wheel torque T is required as the inclination angle R of the road surface is larger. That is, the relationship among the front-rear acceleration AF, the drive wheel torque T, and the inclination angle R of the road surface is determined such that the inclination angle R of the road surface is larger as the drive wheel torque T is higher when the front-rear acceleration AF is constant. Thus, a front-rear acceleration variable, which is a variable that indicates the front-rear acceleration AF, and a drive wheel torque variable, which is a variable that indicates the drive wheel torque T, are preferably used to calculate the inclination angle R of the road surface. In the present embodiment, the front-rear acceleration AF itself is adopted as the front-rear acceleration variable, and the drive wheel torque T itself is adopted as the drive wheel torque variable.

An air resistance acts on the vehicle 500 during travel of the vehicle 500. The air resistance is a travel resistance that acts on the vehicle 500 in the opposite direction of the travel direction of the vehicle 500 because of air. On the assumption that the vehicle 500 maintains a constant front-rear acceleration AF, when the air resistance is large, accordingly high drive wheel torque T is required, even when the inclination angle R of the road surface is invariable. Thus, the magnitude of the air resistance is preferably taken into consideration, rather than the inclination angle R is simply determined in accordance with the magnitude of the drive wheel torque T, in order to precisely calculate the inclination angle R of the road surface. The air resistance is a variable calculated as the product of a frontal projected area of the vehicle 500, an air resistance coefficient, and a square of the vehicle speed SP. That is, the air resistance is a variable that is varied in accordance with the vehicle speed SP. In the present embodiment, the vehicle speed SP is adopted as a variable that indicates the air resistance.

A rolling resistance acts on the vehicle 500 during travel of the vehicle 500. The rolling resistance is a travel resistance due to friction caused between the vehicle 500 and the road surface. As with the air resistance, on the assumption that the vehicle 500 maintains a constant front-rear acceleration, when the rolling resistance is large, accordingly high drive wheel torque T is required, even when the inclination angle R of the road surface is invariable. Thus, the rolling resistance is preferably taken into consideration, in order to precisely calculate the inclination angle R of the road surface. The rolling resistance is a variable calculated as the product of a rolling resistance coefficient and the vehicle weight W. That is, the rolling resistance is a variable that is varied in accordance with the vehicle weight W. In the present embodiment, the vehicle weight W is adopted as a variable that indicates the rolling resistance.

When the vehicle 500 turns, the drive wheel torque T acts as a force that moves the vehicle 500 in both the front-rear direction and the right-left direction. Therefore, the inclination angle R of the road surface may not be calculated appropriately when the relationship between the drive wheel torque T and the inclination angle R of the road surface determined on the assumption that the vehicle 500 is traveling straight is applied to the calculation of the inclination angle R, performed when the vehicle 500 is turning. In view of such circumstances, a variable that indicates turning operation of the vehicle 500 is preferably taken into consideration when calculating the inclination angle R of the road surface. In the present embodiment, the right-left acceleration AL is adopted as a variable that indicates turning operation of the vehicle.

The precision in calculating the inclination angle R of the road surface is improved by calculating the inclination angle R of the road surface after grasping a rough inclination angle of the road surface on which the vehicle 500 is traveling. Thus, an extension inclination angle variable, which is a variable that indicates the extension inclination angle Q, is preferably taken into consideration when calculating the inclination angle R of the road surface. As described above, the extension inclination angle Q is the average inclination angle between adjacent nodes set on the map data N. The inclination angle R of the actual road surface on which the vehicle 500 is traveling is gently recessed and gently projected with a scale that is smaller than the scale of a link between nodes set on the map data N, and the CPU 102 calculates the inclination angle R of the road surface including such recesses and projections with a small scale. The inclination angle R is the inclination angle of the road surface for the travel direction of the vehicle 500 as discussed above, and thus does not coincide with the extension inclination angle Q of the road when the vehicle is traveling obliquely with the road. In the present embodiment, the value of the extension inclination angle Q itself is adopted as the extension inclination angle variable.

In the process in step S10, the CPU 102 acquires the drive wheel torque Tin for calculation as follows. The CPU 102 first calculates output torque of the internal combustion engine 10. When the period since the last execution of the process in step S10 until the current execution of the process in step S10 in the road surface inclination angle calculation process is defined as a data acquisition period, the CPU 102 references a series of data on the crank position Scr that is input from the crank angle sensor 30 to the control device 100 during the data acquisition period, and calculates the average value of a rotational speed (hereinafter referred to as an “engine rotational speed”) NE of the crankshaft 14 per unit time during the period. The CPU 102 references a series of data on the intake air amount GA that is input from the air flow meter 32 to the control device 100 during the data acquisition period, and calculates the average value of the intake air amount GA during the period. The CPU 102 references an engine torque map stored in the storage device 106. The engine torque map indicates the relationship among the engine rotational speed NE, the intake air amount GA, and the output torque of the internal combustion engine 10. The CPU 102 calculates, as average output torque, the output torque of the internal combustion engine 10 corresponding to the average value of the engine rotational speed NE and the average value of the intake air amount GA based on the engine torque map.

Next, the CPU 102 calculates the average value of the rotational speed of the input shaft 51 per unit time during the data acquisition period based on the rotational position 51V of the input shaft 51 of the automatic transmission 50, that is detected by the input shaft rotation sensor 64, using the same method by which the engine rotational speed NE is calculated. The CPU 102 calculates the average value of the rotational speed of the output shaft 52 per unit time during the data acquisition period based on the rotational position 52V of the output shaft 52 of the automatic transmission 50 that is detected by the output shaft rotation sensor 65. The CPU 102 calculates a speed ratio by dividing the rotational speed of the input shaft 51 by the rotational speed of the output shaft 52. The CPU 102 calculates, as average transfer torque, a value obtained by multiplying the average output torque by the speed ratio and the gear ratio of the differential 56.

Next, the CPU 102 calculates braking torque of the braking device. Specifically, the CPU 102 calculates the average value of the brake hydraulic pressure BK during the data acquisition period based on the brake hydraulic pressure BK that is detected by the brake pressure sensor 76 using the same method by which the average value of the intake air amount GA is calculated. After that, the CPU 102 references a brake torque map stored in the storage device 106. The brake torque map indicates the relationship between the brake hydraulic pressure BK and the braking torque. The braking torque is a value obtained by converting the braking force of the braking device into torque. The value of the braking torque becomes larger as the brake hydraulic pressure becomes higher. The CPU 102 calculates, as average braking torque, the braking torque corresponding to the average value of the brake hydraulic pressure BK based on the brake torque map.

When the average transfer torque and the average braking torque are calculated, the CPU 102 calculates the drive wheel torque Tin for calculation by subtracting the average braking torque from the average transfer torque. The CPU 102 calculating the drive wheel torque Tin for calculation corresponds to the CPU 102 acquiring the drive wheel torque Tin for calculation.

The CPU 102 also calculates a value for calculation for each of the front-rear acceleration AF, the right-left acceleration AL, and the vehicle speed SP as the average value during the data acquisition period. That is, the CPU 102 calculates the front-rear acceleration AFin for calculation as the average value during the data acquisition period based on the front-rear acceleration AF that is detected by the acceleration sensor 61.

The CPU 102 calculating the front-rear acceleration AFin for calculation corresponds to the CPU 102 acquiring the front-rear acceleration AFin for calculation. The CPU 102 calculates the right-left acceleration ALin for calculation as the average value during the data acquisition period based on the right-left acceleration AL that is detected by the acceleration sensor 61. The CPU 102 calculating the right-left acceleration ALin for calculation corresponds to the CPU 102 acquiring the right-left acceleration ALin for calculation. The CPU 102 calculates the vehicle speed SPin for calculation as the average value during the data acquisition period based on the vehicle speed SP that is detected by the vehicle speed sensor 63. The CPU 102 calculating the vehicle speed SPin for calculation corresponds to the CPU 102 acquiring the vehicle speed SPin for calculation.

The CPU 102 references the vehicle weight W stored in the storage device 106, and acquires the value as the vehicle weight Win for calculation. The CPU 102 acquires the extension inclination angle Qin for calculation as follows. The CPU 102 references the latest present position coordinate PX detected by the GPS receiver 69, and references the map data N stored in the storage device 106. The CPU 102 determines which road between nodes the present position coordinate PX belongs to on the map data N. The CPU 102 acquires the extension inclination angle Q of the road to which the present position coordinate PX belongs as the extension inclination angle Qin for calculation. When the above variables for calculation required to calculate the inclination angle R of the road surface are acquired, the CPU 102 proceeds to the process in step S20. The process in step S10 is referred to as an “acquisition process”.

In step S20, the CPU 102 substitutes the values of the variables for calculation that are acquired in the process in step S10 into input variables x (1) to x (6) of mapping for calculating the inclination angle R of the road surface. Specifically, the CPU 102 substitutes the drive wheel torque Tin into the input variable x (1), substitutes the front-rear acceleration AFin into the input variable x (2), and substitutes the right-left acceleration ALin into the input variable x (3). The CPU 102 substitutes the vehicle speed SPin into the input variable x (4), substitutes the vehicle weight Win into the input variable x (5), and substitutes the extension inclination angle Qin into the input variable x (6). After that, the CPU 102 proceeds to the process in step S30.

In step S30, the CPU 102 calculates the inclination angle R of the road surface by inputting the input variables x (1) to x (6) to the mapping prescribed by the mapping data M stored in the storage device 106.

In the present embodiment, the mapping is constituted as a fully-connected forward-propagation neural network with a single intermediate layer. The neural network includes an input-side coefficient wFjk (j=0 to n, k=0 to 6) and an activation function h (x) as input-side non-linear mapping. The input-side non-linear mapping performs a non-linear transform on an output of input-side linear mapping. The input-side linear mapping is linear mapping prescribed by the input-side coefficient wFjk.

In the present embodiment, a hyperbolic tangent “tanh (x)” is indicated as an example of the activation function h (x). The neural network includes an output-side coefficient wSj (j=0 to n) and an activation function f (x) as output-side non-linear mapping. The output-side non-linear mapping performs a non-linear transform on an output of output-side linear mapping. The output-side linear mapping is linear mapping prescribed by the output-side coefficient wSj. In the present embodiment, a hyperbolic tangent “tanh (x)” is indicated as an example of the activation function f (x). A value n indicates the dimension of the intermediate layer. In the present embodiment, the value n is smaller than 6, which is the dimension of the input variables x. The input variable wFj0 is a bias parameter, and is a coefficient of the input variable x (0). The input variable x (0) is defined as “1”. The output-side coefficient wS0 is a bias parameter.

The mapping data M are a trained model trained using a vehicle of the same specifications as those of the vehicle 500 before being implemented with the vehicle 500. To train the mapping data M, teacher data and training data are acquired beforehand.

That is, the vehicle is caused to actually travel, and the inclination angle R of the road surface on which the vehicle is traveling is acquired as the teacher data. The inclination angle R of the road surface is measured using a GPS speedometer, for example. The values of the various types of input variables to be used as inputs to the mapping, such as the drive wheel torque T and the front-rear acceleration AF, are acquired as the training data during travel of the vehicle. Sets of the teacher data and the training data for each inclination angle of the road surface are generated by causing the vehicle to travel on road surfaces at various inclination angles. The mapping data M are trained using such teacher data and training data. That is, the input-side coefficient and the output-side coefficient are adjusted such that the difference between a value output from the mapping data M when the training data are input and the value of the teacher data for the inclination angle R of the actual road surface becomes equal to or less than a predetermined value for road surfaces at various inclination angles. The training is completed when the above difference becomes equal to or less than the predetermined value.

The CPU 102 temporarily ends the sequence of processes of the road surface inclination angle calculation process when the inclination angle R of the road surface is calculated in step S30. The CPU 102 executes the process in S10 again. The process in step S30 is referred to as a “calculation process”.

Next, the function of the present embodiment will be described. The inclination angle R of the road surface is calculated when the drive wheel torque Tin, the front-rear acceleration AFin, the right-left acceleration ALin, the vehicle speed SPin, the vehicle weight Win, and the extension inclination angle Qin for calculation are input to the input variables x (1) to x (6) for the mapping during travel of the vehicle 500.

Next, the effect of the present embodiment will be described.

(1) With the configuration described above, as described in the above function, the inclination angle R of the road surface on which the vehicle 500 is traveling can be calculated at all times during travel of the vehicle 500. When the inclination angle R can be calculated consecutively in this manner, the travel state of the vehicle 500 can be controlled in consideration of the inclination angle R of the road surface during travel of the vehicle 500. This is suitable for the calculation of a required drive force that is necessary for travel of the vehicle 500 and the control of a hydraulic pressure that acts on the engagement elements of the automatic transmission, for example.

(2) In the configuration described above, the input variables for the mapping include the drive wheel torque T and the front-rear acceleration AF. The relationship among the drive wheel torque T, the front-rear acceleration AF, and the inclination angle R of the road surface is determined such that the inclination angle R of the road surface is larger as the drive wheel torque T is higher when the front-rear acceleration AF is constant. Thus, the inclination angle R of the road surface can be calculated precisely by including the drive wheel torque T and the front-rear acceleration AF in the input variables.

(3) In the configuration described above, the input variables include the vehicle speed SP that indicates the air resistance. Thus, the inclination angle R of the road surface can be calculated based on the travel state of the vehicle 500 determined in consideration of the air resistance. Therefore, the precision in calculating the inclination angle R of the road surface is improved compared to the case where the inclination angle R of the road surface is calculated without taking the air resistance into consideration.

(4) In the configuration described above, the input variables include the vehicle weight W that indicates the rolling resistance. Thus, the inclination angle R of the road surface can be calculated based on the travel state of the vehicle 500 determined in consideration of the rolling resistance. Therefore, the precision in calculating the inclination angle R of the road surface is improved compared to the case where the inclination angle R of the road surface is calculated without taking the rolling resistance into consideration.

(5) In the configuration described above, the input variables include the extension inclination angle Q. Thus, the inclination angle R of the actual road surface can be calculated as a value that reflects a rough inclination angle of the road surface. In this case, the precision in calculating the inclination angle R of the road surface is improved compared to the case where the inclination angle R of the road surface is calculated without any information on a rough inclination angle of the road surface.

(6) In the configuration described above, the input variables include the right-left acceleration AL. Thus, the inclination angle R of the road surface can be calculated based on the travel state of the vehicle 500 determined in consideration of turning of the vehicle 500. Therefore, the precision in calculating the inclination angle R of the road surface is improved compared to the case where the inclination angle R of the road surface is calculated without taking turning of the vehicle 500 into consideration.

(7) In the configuration described above, the values of the input variables are calculated as average values during the data acquisition period. Thus, the effect of an error or noise due to the sensors on the values of the input variables can be reduced. The precision in calculating the inclination angle R of the road surface is improved by calculating the inclination angle R of the road surface using such input variables.

The present embodiment may be modified as follows. The present embodiment and the following modifications can be combined with each other unless such an embodiment and modifications technically contradict with each other. For example, a part of the road surface inclination angle calculation process may be performed by a computer that is external to the vehicle 500. For example, a server 600 may be provided outside the vehicle 500 as illustrated in FIG. 3. The server 600 may be configured to perform the road surface inclination angle calculation process. In this case, the server 600 may be constituted as one or more processors that execute various types of processes in accordance with a computer program (software). The server 600 may be constituted as one or more dedicated hardware circuits such as application-specific integrated circuits (ASICs) that execute at least a part of the various types of processes, or circuitry that includes a combination of such circuits. The processor includes a CPU 602 and a memory such as a RAM and a ROM 604. The memory stores program codes or instructions configured to cause the CPU 602 to execute the processes. The memory, which is a computer readable medium, includes any available medium that can be accessed by a general-purpose or dedicated computer. The server 600 has a storage device 606. The storage device 606 is a non-volatile memory that is electrically rewritable. The storage device 606 stores the mapping data M described in the above embodiment. The server 600 has a communication unit 610 to connect to the outside of the server 600 through an external communication line network 700. The CPU 602, the ROM 604, the storage device 606, and the communication unit 610 can communicate with each other through an internal bus 608.

When the road surface inclination angle calculation process is performed by the server 600, the control device 100 of the vehicle 500 has a communication unit 110 to communicate with the outside of the control device 100 through the external communication line network 700. The configuration of the control device 100 is the same as that of the control device 100 according to the embodiment described above, except for having the communication unit 110. Therefore, the control device 100 is not described in detail. Components in FIG. 3 with the same function as those in FIG. 1 are given the same reference signs as those in FIG. 1. The control device 100 and the server 600 constitute a road surface inclination angle calculation system Z.

When the road surface inclination angle calculation process is performed by the server 600, the control device 100 of the vehicle 500 first performs the acquisition process that is the process in step S10 according to the embodiment described above. When the control device 100 acquires variations for calculation through the process in step S10, the control device 100 transmits the values of the acquired variables to the server 600. When the CPU 602 of the server 600 receives the values of the variables, the CPU 602 of the server 600 calculates the inclination angle R of the road surface by performing the processes in steps S20 and S30 according to the embodiment described above. The CPU 602 of the server 600 performs the processes in steps S20 and S30 by executing a program stored in the ROM 604.

When the control device 100 of the vehicle 500 and the server 600 perform the road surface inclination angle calculation process as in this modification, the CPU 102 and the ROM 104 of the control device 100 of the vehicle 500 and the CPU 602 and the ROM 604 of the server 600 constitute the execution device.

Alternatively, all of the processes of the road surface inclination angle calculation process may be performed by a computer that is external to the vehicle 500. For example, when the server 600 is provided outside the vehicle 500 as in the modification described above, the control device 100 of the vehicle 500 transmits detection signals from the various types of sensors attached to the vehicle 500 to the server 600. The CPU 602 of the server 600 acquires the values of the variables for calculation by performing a process corresponding to step S10 according to the embodiment described above. After that, the CPU 602 of the server 600 performs processes corresponding to steps S20 and S30, as in the modification described above. In such a configuration, the server 600 performs the acquisition process and the calculation process. When the acquisition process is performed by the server 600, information that is necessary for the acquisition process such as the engine torque map and the map data may be stored in the storage device 606.

The method of calculating the various types of variables for calculation in step S10 is not limited to the method that uses average values such as that described in relation to the above embodiment. For example, time-series data of detection signals input from the various types of sensors to the control device 100 may be subjected to a moving average filter etc. to calculate appropriate values.

In calculating the various types of variables for calculation, instantaneous values of the drive wheel torque T and the vehicle speed SP may be calculated, rather than calculating average values as in the embodiment described above. For example, instantaneous values of the variables may be calculated using the latest values, at the time of execution of the process in step S10, of detection signals input from the various types of sensors to the control device 100.

A differential value of the vehicle speed SP may be used to calculate the front-rear acceleration AFin for input.

Further, the rotational position 52V of the output shaft 52 of the automatic transmission 50 may be used to calculate the vehicle speed SPin for input.

The configuration of the vehicle 500 is not limited to the example of the embodiment described above. For example, not only the internal combustion engine 10 but also a motor may be mounted as a drive source of the vehicle 500. Alternatively, only a motor may be mounted as a drive source of the vehicle 500, in place of the internal combustion engine 10. When a motor is mounted as a drive source of the vehicle 500, the drive wheel torque T may be calculated in consideration of output torque of the motor.

The variable adopted as the drive wheel torque variable is not limited to the example of the embodiment described above. For example, a value obtained by multiplying the drive wheel torque T by the wheel diameter may be adopted as the drive wheel torque variable. It is only necessary that the drive wheel torque variable should be a variable that indicates the drive wheel torque T.

The variable adopted as the front-rear acceleration variable is not limited to the example of the embodiment described above. The front-rear acceleration variable may be a value obtained by multiplying the front-rear acceleration AF by an appropriate coefficient, for example. This coefficient may be increased and decreased in accordance with the reliability of the front-rear acceleration AF calculated based on the front-rear acceleration AF detected by the acceleration sensor 61 or a detection value of the vehicle speed sensor 63, for example. For example, the coefficient described above may be a value that is close to 1 when the difference between the front-rear acceleration AF detected by the acceleration sensor 61 and the front-rear acceleration AF calculated as a differential value of the vehicle speed SP is small, and may be a value that is close to zero when such a difference is large.

The variable adopted as the vehicle speed variable is not limited to the example of the embodiment described above. For example, a value obtained by multiplying the vehicle speed SP by an air resistance coefficient and the frontal projected area of the vehicle 500 may be adopted as the vehicle speed variable. It is only necessary that the vehicle speed variable should be a variable that matches the vehicle speed SP, that is, a variable that reflects the air resistance.

The variable adopted as the weight variable is not limited to the example of the embodiment described above. For example, a value obtained by multiplying the vehicle weight by a rolling resistance coefficient may be adopted as the weight variable. It is only necessary that the weight variable should be a variable that matches the weight variable, that is, a variable that reflects the rolling resistance.

The variable adopted as the variable that indicates turning of the vehicle 500 is not limited to the example of the embodiment described above. For example, the turning angle of a steering wheel may be adopted as the variable that indicates turning of the vehicle 500. It is only necessary that the variable that indicates turning of the vehicle 500 should be a variable that allows grasping turning of the vehicle 500.

The variable adopted as the extension inclination angle variable is not limited to the example of the embodiment described above. For example, a plurality of levels may be set in accordance with the degree of the extension inclination angle Q, and a value that indicates such a level may be adopted as the extension inclination angle variable. It is only necessary that the extension inclination angle variable should be a variable that indicates the extension inclination angle Q.

As in the modification described above, a plurality of levels may be set in accordance with the degree of other variables such as the drive wheel torque variable and the front-rear acceleration variable, and a value that indicates such a level may be adopted as the variables.

The types of the input variables are not limited to the example of the embodiment described above. Other input variables may be adopted in place of or in addition to those input variables described in the above embodiment. The number of input variables may be decreased from the number according to the embodiment described above. Any number of input variables may be used. However, the front-rear acceleration variable is essential as an input variable.

A plurality of parameters related to the drive wheel torque may be input as the input variables, in place of the drive wheel torque variable. In this case, the input variables may include a drive source torque variable, which is a variable that indicates output torque of the drive source of the vehicle 500 such as the internal combustion engine or the motor, a gear ratio variable, which is a variable that indicates the gear ratio of a power transfer system that extends from the drive source of the vehicle 500 to the drive wheel, and a braking variable, which is a variable that indicates the braking force of the braking device of the vehicle 500.

The vehicle speed variable, the weight variable, the variable that indicates turning of the vehicle 500, and the extension inclination angle variable are not essential as input variables. The inclination angle R of the road surface can be calculated considerably precisely, even when such variables are not input, as long as the drive wheel torque variable or other substituting variables and the front-rear acceleration variable are included in the input variables. The variables substituting the drive wheel torque variable include the drive source torque variable, the gear ratio variable, and the braking variable described in the above modification.

Variables other than the variables described in the above embodiment may be adopted as the input variables. For example, a front-rear acceleration acts on the vehicle 500 along with shifting operation during shifting of the automatic transmission 50. The front-rear acceleration AF at this time is not associated with the inclination angle R of the road surface. Thus, a variable that indicates whether the automatic transmission 50 is shifting may be included in the input variables, in order to calculate the inclination angle R of the road surface separately from the front-rear acceleration AF during shifting of the automatic transmission 50.

The input variables may include an up-down acceleration variable that indicates the acceleration of the vehicle 500 in the up-down direction. When the input variables include the up-down acceleration variable, it is possible to reflect information related to the amount of movement of the vehicle 500 in the up-down direction in the calculation of the inclination angle R of the road surface, for example.

The output variable is not limited to the example of the embodiment described above. It is only necessary that the output variable should be an inclination angle variable that is a variable indicating the inclination angle R of the road surface. For example, a plurality of levels may be set in accordance with the degree of the inclination angle R of the road surface, and a value that indicates such a level may be adopted as the inclination angle variable.

The configuration of the mapping is not limited to the example of the embodiment described above. For example, the neural network may include two or more intermediate layers.

Further, a recurrent neural network may be adopted as the neural network, for example. In this case, the values of the input variables in the past are reflected in the current calculation of a new value of the output variable, and thus such a neural network is suitable for calculating the inclination angle R of the road surface while reflecting the past history.

The method of acquiring training data and teacher data to be used to train the mapping data M is not limited to the example of the embodiment described above. For example, in acquiring the inclination angle R of the road surface as teacher data, the inclination angle R of the road surface may be calculated from the travel distance of the vehicle within a predetermined period and the difference in the height over which the vehicle has traveled within the same period. In acquiring training data and teacher data, the internal combustion engine and the automatic transmission may be coupled to a chassis dynamometer to simulate a state in which the vehicle is actually traveling, rather than causing the vehicle to actually travel. Training data may be acquired by applying, to the vehicle, a load that is similar to that applied when the vehicle is traveling on an inclined road surface.

What is claimed is:

1. A road surface inclination angle calculation device comprising:
a storage device configured to store mapping data that prescribes mapping, the mapping including, as input variables, a front-rear acceleration variable that is a variable indicating an acceleration of a vehicle in a front-rear direction and a drive wheel torque variable that is a variable indicating torque of a drive wheel of the vehicle, and the mapping including, as an output variable, an inclination angle variable that is a variable indicating an inclination angle of a road surface on which the vehicle is traveling for a travel direction of the vehicle; and
an execution device configured to acquire values of the input variables and configured to calculate a value of the output variable by inputting the acquired values of the input variables to the mapping.

2. The road surface inclination angle calculation device according to claim 1, wherein the input variables include a vehicle speed variable that is a variable corresponding to a travel speed of the vehicle.

3. The road surface inclination angle calculation device according to claim 1, wherein the input variables include a weight variable that is a variable corresponding to a weight of the vehicle.

4. The road surface inclination angle calculation device according to claim 1, wherein the input variables include an extension inclination angle variable that is a variable indicating the inclination angle of the road surface for an extension direction of a road at a present position of the vehicle, and the extension inclination angle variable is determined in advance as map information stored in the storage device.

5. A road surface inclination angle calculation device comprising:
a storage device configured to store mapping data that prescribes mapping, the mapping including, as input variables, a front-rear acceleration variable that is a variable indicating an acceleration of a vehicle in a front-rear direction, a drive source torque variable that is a variable indicating output torque of a drive source of the vehicle, a gear ratio variable that is a variable indicating a gear ratio of a power transfer system that is provided on a power transfer pass between the drive source and a drive wheel in the vehicle, and a braking variable that is a variable indicating a braking force of a braking device of the vehicle, and the mapping including, as an output variable, an inclination angle variable that is a variable indicating an inclination angle of a road surface on which the vehicle is traveling for a travel direction of the vehicle; and
an execution device configured to acquire values of the input variables and configured to calculate a value of the output variable by inputting the acquired values of the input variables to the mapping.

6. The road surface inclination angle calculation device according to claim 5, wherein the input variables include a vehicle speed variable that is a variable corresponding to a travel speed of the vehicle.

7. The road surface inclination angle calculation device according to claim 5, wherein the input variables include a weight variable that is a variable corresponding to a weight of the vehicle.

8. The road surface inclination angle calculation device according to claim 5, wherein the input variables include an extension inclination angle variable that is a variable indicating the inclination angle of the road surface for an extension direction of a road at a present position of the vehicle, and the extension inclination angle variable is determined in advance as map information stored in the storage device.
